(19) United States
(12) Patent Application Publication
(10) Pub. No.: US 2020/0327072 A1
(43) Pub. Date: Oct. 15, 2020

(54) SECURE-ATS USING VERSING TREE FOR REPLY PROTECTION

(71) Applicant: Intel Corporation, Santa Clara, CA (US)

(72) Inventors: Michael Kounavis, Portland, OR (US); Anna Trikalinou, Hillsboro, OR (US)

(73) Assignee: Intel Corporation, Santa Clara, CA (US)

(21) Appl. No.: 16/912,251

(22) Filed: Jun. 25, 2020

(51) Int. Cl. G06F 12/14; G06F 12/1081; G06F 12/0882; G06F 21/79; H04L 9/06; H04L 9/32

(52) U.S. Cl. CPC G06F 12/1408; G06F 12/1081; G06F 12/0882; H04L 9/3242; H04L 9/0631; H04L 9/0637; H04L 9/0643; G06F 21/79

(57) ABSTRACT

Methods and apparatus relating to secure-ATS (or secure Address Translation Services) using a version tree for replay protection are described. In an embodiment, memory stores data for a secured device. The stored data comprising information for one or more intermediate nodes and one or more leaf nodes. Logic circuitry allows/disallows access to contents of a memory region associated with a first leaf node from the one or more leaf nodes by a memory access request based at least in part on whether the memory access request is associated with a permission authenticated by the MAC of the first leaf node. Other embodiments are also disclosed and claimed.

### FIELD

The present disclosure generally relates to the field of electronics. More particularly, an embodiment relates to secure-ATS (or secure Address Translation Services) using a version tree for replay protection.

### BACKGROUND

Most modern systems use memory virtualization for optimal memory usage and security. Traditionally, PCIe or PCI-E (Peripheral Component Interconnect express) devices would only observe Virtual Addresses (VA), as opposed to Physical Addresses (PA), and would send a read or write request with a given VA. On the host side, the processor's I/O (Input/Output) Memory Management Unit (IOMMU) would receive the device's read/write request, translate the VA to PA, and complete the device's memory access operation (e.g., read/write).

Moreover, Address Translation Services (ATS) is an extension to the PCI-E protocol, which allows a PCI-E device to request address translations, from VA to PA, from a Translation Agent, such as an IOMMU.

ATS is an important capability because it allows devices to handle page faults, which can be a requirement for supporting other performance features. Also, ATS can be requirement to support cache-coherent links.

However, the current ATS definition has a security vulnerability. Specifically, a malicious ATS device can send a Translated Request with an arbitrary PA and perform a read/write to that PA, without first asking for a translation or permission from the trusted system IOMMU.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1. illustrates an example implementation of Secure ATS version tree, according to an embodiment.

FIGS. 2 and 3 illustrate high-level flow diagrams of methods according to some embodiments.

FIGS. 4, 5, 6, and 7 illustrate sample version trees, according to some embodiments.

FIGS. 8 and 9 illustrates block diagrams of embodiments of computing systems, which may be utilized in various embodiments discussed herein.

FIGS. 10 and 11 illustrate various components of processers in accordance with some embodiments.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As mentioned above, most modern systems use memory virtualization for optimal memory usage and security. Traditionally, PCIe or PCI-E (Peripheral Component Interconnect express) devices would only observe Virtual Addresses (VA), as opposed to Physical Addresses (PA), and would send a read or write request with a given VA. On the host side, the processor's I/O (Input/Output) Memory Management Unit (IOMMU) would receive the device's read/write request, translate the VA to PA, and complete the device's memory access operation (e.g., read/write).

Moreover, Address Translation Services (ATS) is an extension to the PCI-E protocol, which allows a PCI-E device to request address translations, from VA to PA, from a Translation Agent, such as an IOMMU. This capability allows the device to store the resulting translations internally, e.g., in a Device Translation Lookaside Buffer (Dev-TLB), and directly use the resulting PA to access memory, either via the PCI-E interface or via a cache-coherent interface like Compute Express Link (CXL). In other words, ATS splits a legacy PCI-E memory access in multiple stages: (a) Page Request, where the device requests from the IOMMU for a new page to be allocated for it (optional step), (b) Translation Request, where the device requests for a VA to PA translation, the IOMMU performs the page walk and sends the resulting PA and, finally, the device stores the PA in the device's Dev-TLB cache, and (c) Translated Request, where the device requests a read/write with a given PA.

ATS is an important capability because it allows devices to handle page faults (more traditional PCI-E devices required memory pinning), which is a requirement for supporting other performance features, like Shared Virtual Memory and VMM (Virtual Machine Monitor) Memory Overcommit. Generally, “memory overcommitment” refers to assignment of more memory to virtual computing devices/processes than the physical machine (they are hosted or running on) actually has. Also, ATS can be required, for example, in order to support cache-coherent links like CXL.

However, the current ATS definition has a security vulnerability. Specifically, a malicious ATS device (such as a chip on the device that is compromised or a man in the middle) can send a Translated Request with an arbitrary PA and perform a read/write to that PA, without first asking for a translation or permission from the trusted system IOMMU.

To this end, some embodiments relate to secure-ATS (or secure Address Translation Services, sometimes also referred to as “S-ATS”) using a version tree for replay protection. An embodiment considers a physical attacker in scope and provides an access control mechanism that is resilient to memory corruption and/or memory replay attacks. For example, the access control mechanism can operate such that a malicious device can only access PAs that were explicitly assigned to that device by trusted system software. Moreover, since at least one threat model includes protection against a malicious, physical device, it can be assumed that a physical attacker is present. As a result, access control may be provided even in the presence of a physical attacker who can arbitrarily tamper memory operations (e.g., read/write) or perform a replay attack. One or more embodiments enable multiple performance features, including Shared Virtual Memory, VMM Overcommit capability, and cache-coherent links like CXL.

In at least one embodiment, access control is provided such that a malicious or vulnerable device can only access PAs that were explicitly assigned to that device by the trusted system software. Additionally, since the threat model includes protection against a malicious, physical device, it is assumed that a physical attacker is present. Hence, in this solution access control even in the presence of a physical attacker who can arbitrarily tamper (read/write) memory or perform a replay attack. Moreover, in an embodiment, the leaf nodes of the version tree store permission(s) for a memory region associated with a leaf node (and not the actual memory content). The tree may then be used to authenticate a set of permissions.

By contrast, some current approaches (such as the current ATS specification) may provide checks on every ATS Translated Request with a PA to verify that the device that sent the memory access request is enabled by the system software to use ATS. This can allow the system software to check the device manufacturer, before enabling the capability. However, without device authentication, this information can be easily forged by an attacker. In addition, device authentication cannot guarantee the proper behavior of a device with reconfigurable hardware logic, such as an FPGA (Field-Programmable Gate Array) device. Another check may indicate whether the PA is not part of a system protected range, such as the Guard Extensions (SGX) Processor Reserved Protected Memory (PRMRR) region, provided by Intel® Corporation. This check can verify that highly-sensitive system regions are protected from an ATS device, but all other memory, i.e. ring −1, ring 0, ring 3 code/data remains vulnerable.

Another protection could be Trust Domain Extension (TDX), which includes per-Trust Domain (TD) encryption key. However, if ATS is enabled, a malicious ATS device that is not trusted by any TD can still write to any host PA (HPA) with the wrong key, which will result in corrupting or causing a Denial of Service attack to any TD or the VMM (Virtual Memory Machine) itself. On the other hand, if TDX chooses to disable ATS in that platform, then TDX would be incompatible with devices that use cache-coherent links like CXL, and will be incompatible with other host performance features like Shared Virtual Memory and VMM Overcommit. So, this will force software vendors to have to choose between performance vs. security. Hence, some embodiments allow for provision of secure ATS (e.g., for discrete devices) to enable multiple performance features, including Shared Virtual Memory, VMM Overcommit capability, and cache-coherent links like CXL.

In order to provide both access control against a malicious device transaction and confidentiality, integrity and freshness guarantees against a physical attacker, a construct is proposed for S-ATS that utilizes a version tree. For every ATS device in the system, a separate tree 100 is built, which will includes a Root Node 102, one or more levels of Intermediate Nodes 104 and Leaf Nodes 106, as shown in Fig. In an embodiment, the leaf nodes store permission(s) for a memory region associated with a leaf node (and not the actual memory content). The tree may then be used to authenticate a set of permissions.

Moreover, depending on the implementation, the tree height may vary, e.g., an intermediate node can point to another intermediate node and so on. Also, each Leaf node may contain n permissions (such as Read and Write permissions), which describe whether the given device can perform a memory access to a corresponding Host Physical Address (HPA). Each Leaf node will also contain a Message Authentication Code (MAC), which may be produced using Equation 1:

Encryption_{Key}(Node Contents,Counter of Parent Node)=MAC (Equation 1)

This equation may be used for producing the Version Tree MACs. An example cryptographic algorithm for encryption can be AES-GCM (wherein “AES” refers to Advanced Encryption Standard and “GCM” refers to Galois/Counter Mode). However, embodiments are not limited to AES-GCM. Moreover, as discussed herein “encryption” or “decryption” are intended to encompass a range of cryptographic algorithms, including but not limited to, block cipher processing, one way cryptographic hash function(s), stream cipher processing, Hashed Message Authentication Code (HMAC) and/or Keyed Message Authentication Code (KMAC) codes, AES-GCM, etc.

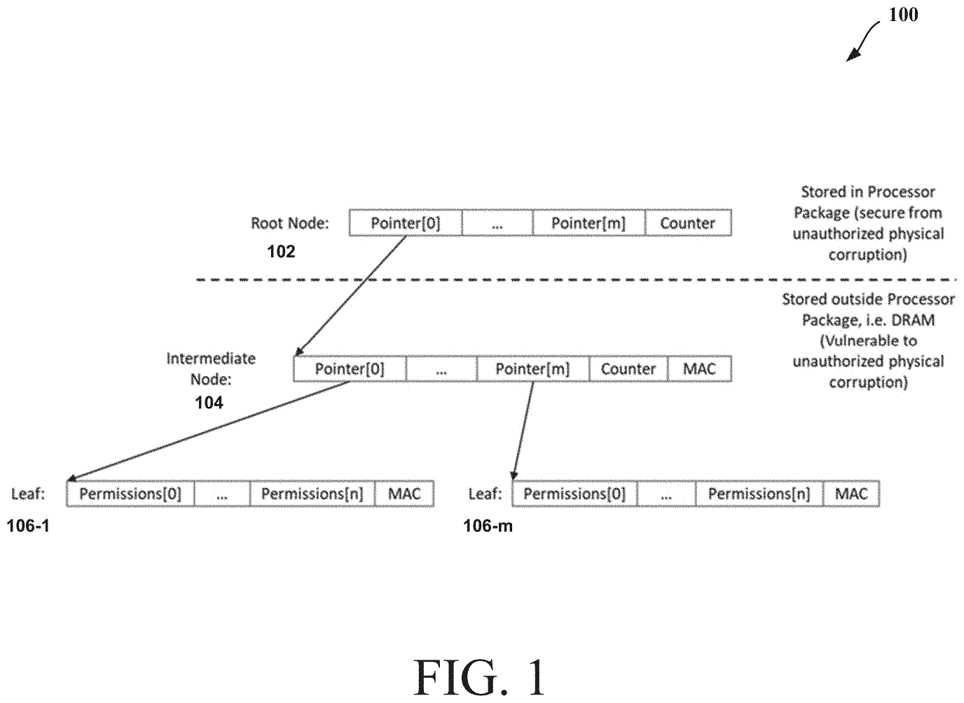

Referring to FIG. 1, Intermediate Nodes 104 would contain a series of m pointers, which could point to either another intermediate node or to a Leaf Node 106. The Pointer structure which is depicted in FIG. 1 Fig., may consist of an address (e.g., 52 bits) and a Valid bit, which may, for example, be 1, if the pointer has been assigned or 0, otherwise, or vice versa. Additionally, the Intermediate Node(s) may contain a Counter, which would be used in the computation of the MAC for each of their child nodes. Lastly, each Intermediate Node would also contain a MAC, which may be produced using Equation 1.

Finally, the Root Node 102 would contain a set of pointers (which point to intermediate node(s) 104) and a Root Node Counter. The Root Node is considered to be the Root of Trust for this mechanism and the Root Node would be stored inside the Processor Package/hardware, which is assumed to be secure from physical tampering. On the other hand, all other Nodes are stored in external memory (e.g., DRAM, NVM, CXL, etc.), which may be tampered by a physical attacker. This is a valid assumption, given that there is no published work so far that can successfully retrieve data from the processor package, while still maintaining power to it and without destroying it permanently.

To ensure confidentiality of the permission version tree, each node of the Version Tree, apart from the Root Node, will be encrypted by the processor (e.g., using AES-GCM) before sending the data to memory for storage. Given the Root of Trust is secure from physical attacks, cryptography can be used (e.g., AES-GCM) to provide encryption, integrity, and freshness guarantees from physical attacks even for the Leaf Nodes 106-1 through 106-m (collectively referred to herein as leaf nodes 106).

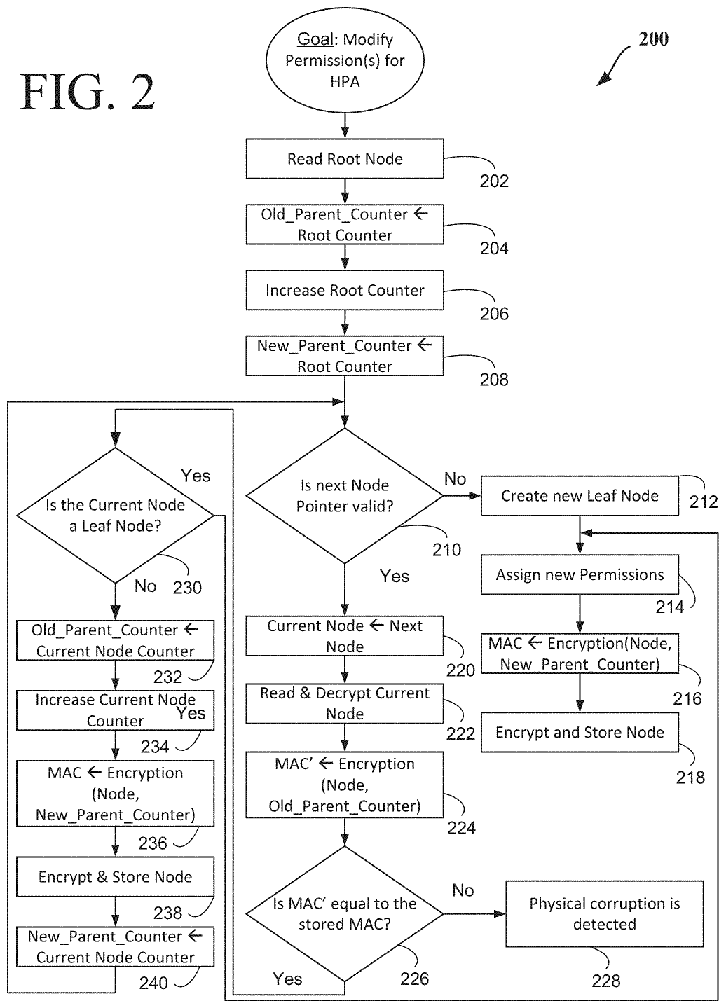

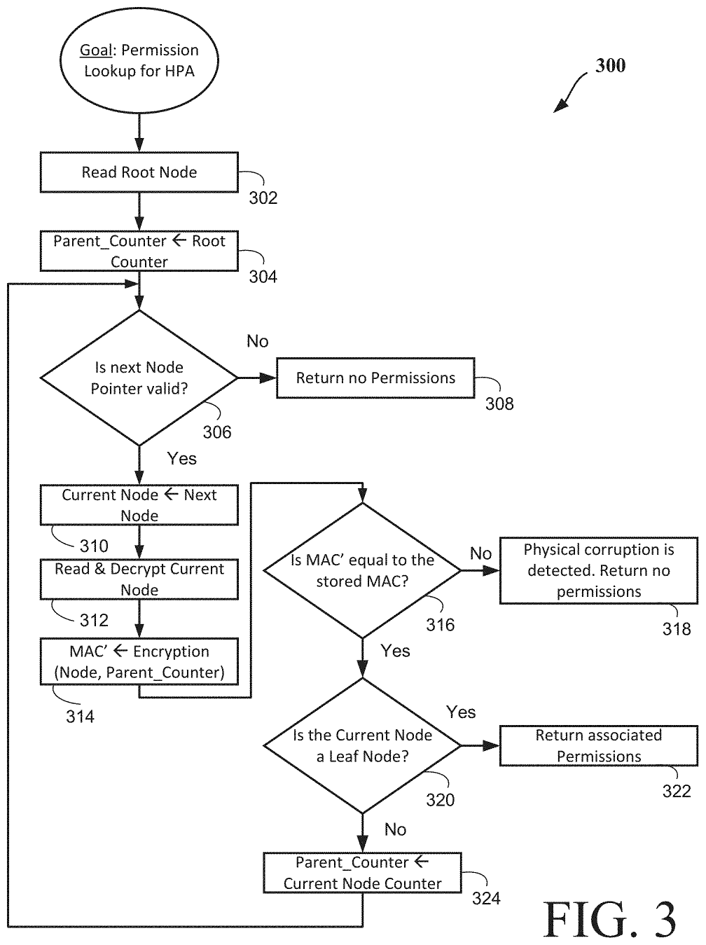

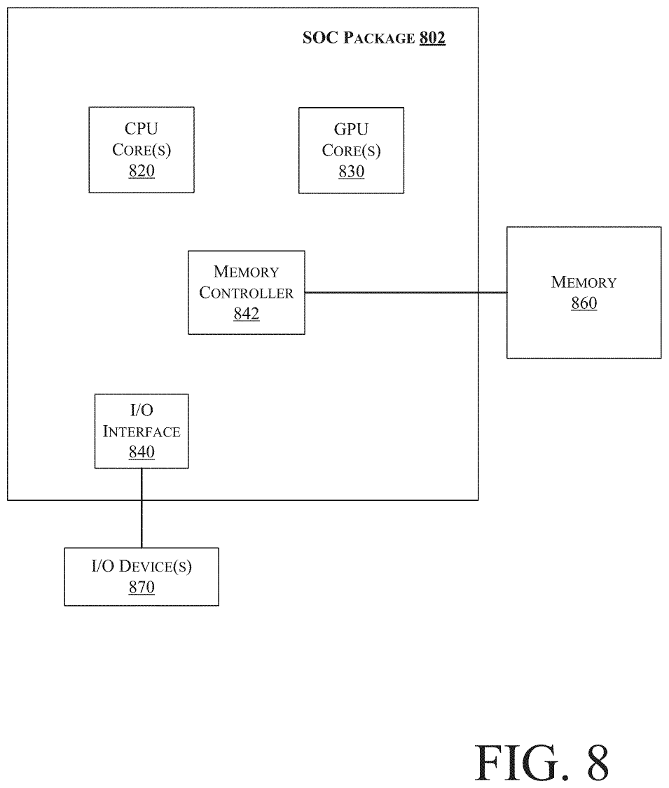

FIG. 2 illustrates a high-level flow diagram for modifying the version tree by adding a new Leaf to the Tree or modifying an existing Leaf Node to add new permissions, according to an embodiment. FIG. 3 illustrates a high-level flow diagram for permission lookup given the HPA that the device requested to access. One or more operations discussed with reference to FIGS. 1-7 are performed by components of a computing device/system such as those discussed with reference to FIGS. 8-11, including for example a processor, memory, logic, etc. Also, as discussed above, the permission information may be stored in a Device Translation Lookaside Buffer (Dev-TLB) in some embodiments. The Dev-TLB may be stored in various locations such as an on-chip memory (e.g., where the on-chip memory is in the processor package). Also, while some operations herein may refer to encrypting/decrypting the current node, this may be only the case in some embodiments and the encryption/decryption of the current node may be omitted in other embodiments. For example, in one or more embodiments, encryption is the identify function Enc(x)<−x (where Enc(x) refers to an encrypted version of x).

Referring to FIG. 2, a method 200 is shown for adding a new leaf node or modify an existing leaf node of the S-ATS Version Tree, according to some embodiments. Hence, one goal of method 200 is to modify one or more permissions for the HPA. At an operation 202, the root node data is read. Operation 204 sets the old parent counter to the root counter. Operation 206 increments the root counter and operation 208 sets the new parent counter to the updated root counter value.

At operation 210, if the next node pointer is invalid (or otherwise does not already exist), operation 212 creates a new leaf node, operation 214 assigns new permissions for the new leaf node, operation 216 sets the MAC for the new leaf node to a new value (determined by encryption of the node, and new parent counter) per Equation 1, and operation 218 encrypts and stores the information/data for the new leaf node.

If the next node pointer is valid at operation 210, operation 220 sets the current node to the next node, operation 222 reads and decrypts the current node data, and operation 224 sets the new MAC′ to the determined encryption of the node and old parent counter per Equation 1. Subsequently, if the new MAC′ is not the same as the stored MAC value at operation 226, operation 228 reports detection of a physical corruption.

Alternatively, if the new MAC′ and stored MAC values match at operation 226, operation 230 determines whether the current node under consideration is a leaf node and if so method 200 continues with operation 214. Otherwise, operation 232 sets the old parent counter value to the current node counter value, operation 234 increments the current node counter value, and operation 236 determines the MAC based on encryption of node and new parent counter per Equation 1. Operation 238 encrypts and stores the new Node data and operation 240 sets the new parent counter value to the current node counter value. After operation 240, method 200 resumes at operation 210 to determine whether the next node pointer is valid.

Referring to FIG. 3, a method 300 is shown for reading a device's access permissions from the S-ATS Version Tree for a given HPA, according to an embodiment. Hence, one goal of method 300 is to perform permission lookup for the HPA. At operation 302, the root node information is read. Operation 304 sets the parent counter value to the root counter value. Operation 306 determines whether the next node pointer is valid and if not operation 308 returns no permissions.

If the next node pointer is determined to be valid at operation 306, operation 310 sets the current node to the next node, operation 312 reads and decrypts the current node data, and operation 314 computes the new MAC′ by encrypting the node and parent counter information per Equation 1. Operation 316 then determines whether the new MAC′ matches the stored MAC and of not, operation 318 reports detection of physical corruption and method 300 returns to no permissions (e.g., like operation 308).

If the new MAC′ and stored MAC match at operation 316, operation 320 determines whether the current node under consideration is a leaf and if so, returns the associated permissions at operation 322. Otherwise, operation 324 sets the parent counter to the current node counter and method 300 resumes with operation 306.

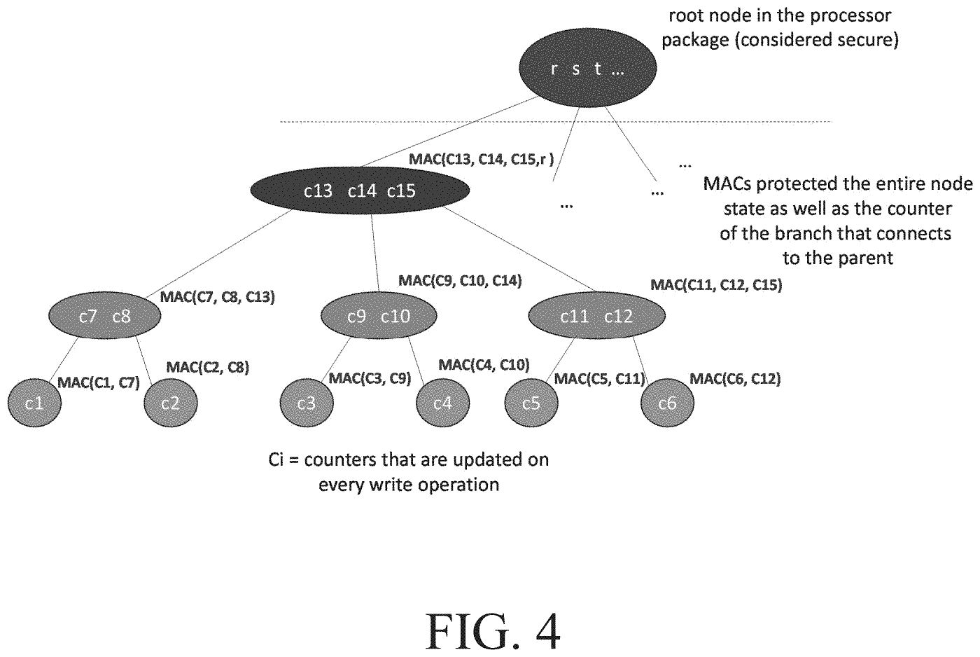

FIGS. 4, 5, 6, and 7 illustrate sample version trees, according to some embodiments. Each node shown as some sample counter labels for illustrative purposes and not intended as a limitation (where Ci refers to counters that are updated at every write operation).

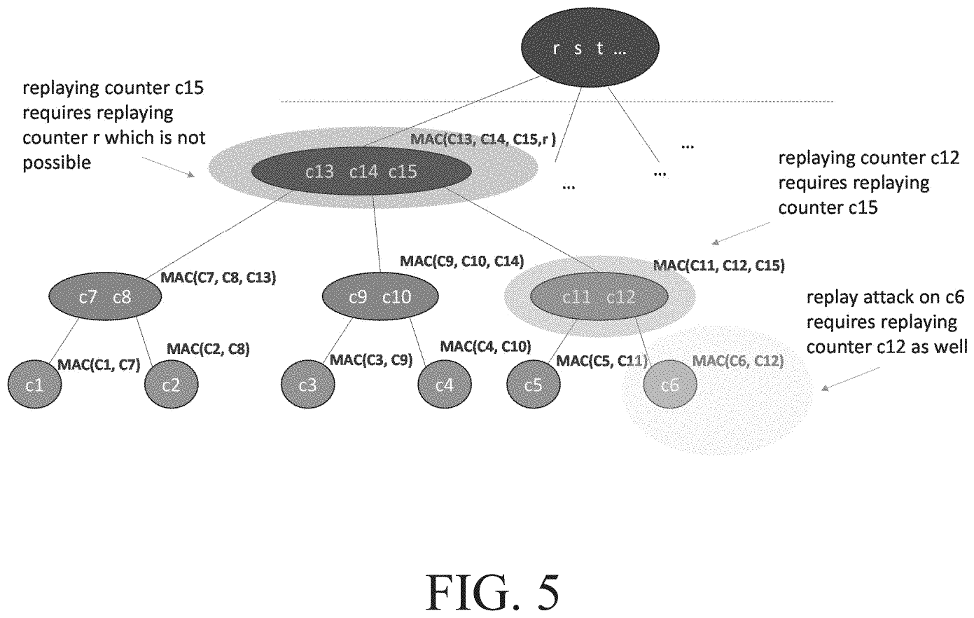

More particularly, FIG. 4 shows a sample version tree with a root node (rst) and various leaf and sub-leaf nodes. FIG. 5 illustrates how a replay attack is prevented using the version tree concept. For example if a replay attack is directed at C6, replay of counter C12 is also required (since the MAC of C6 includes the parent node C12), replaying counter C12 requires the replay of its parent counter C15, and replaying counter C15 requires replaying of counter r which is by definition secure (since the root node is assumed to be in the processor package instead of being stored outside the processor package and potentially vulnerable). Hence, nodes C1-C6 are being protected from a replay attach (even if they are cryptographically protected).

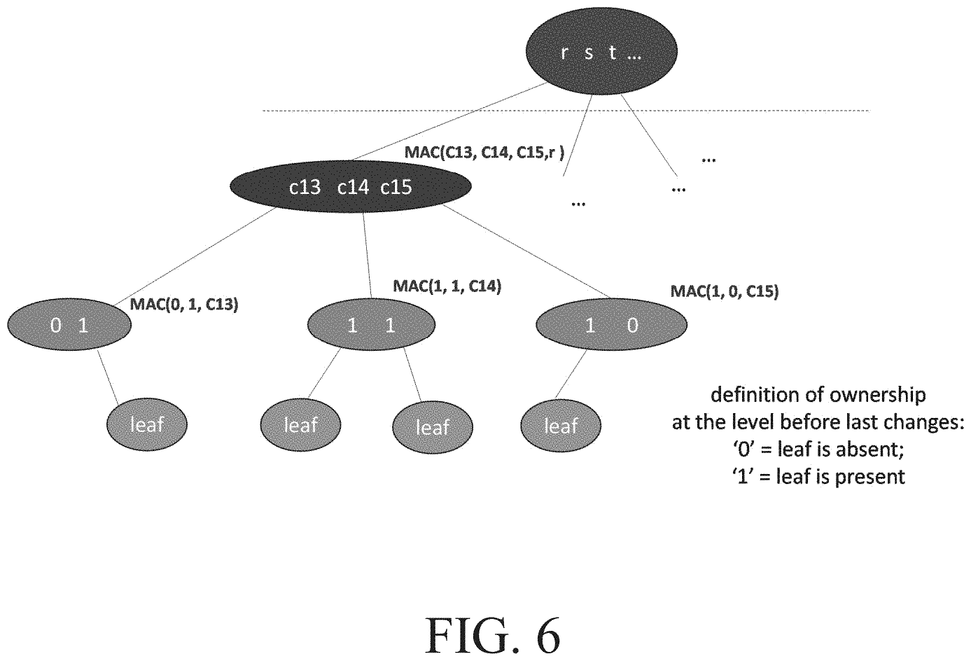

FIG. 6 illustrates how the version tree could also be modified to show ownership, where a “0” at a level indicates absence of a child leaf and “1” indicates presence of a child leaf. Alternatively, these values could be reversed or other values may designate presence/absence of a child leaf depending on the implementation. In at least one embodiment, presence of a leaf indicates a memory page has been assigned to a (e.g., PCI-E) device, which may be referred to herein as a positive tree. Alternatively, presence of a leaf may indicate that a memory page has been removed for a device (i.e., invalidated), which may be referred to herein as a negative tree. This ownership approach can provide a much faster and/or efficient add/remove operations because of ease of use, insertion/removal in a tree structure.

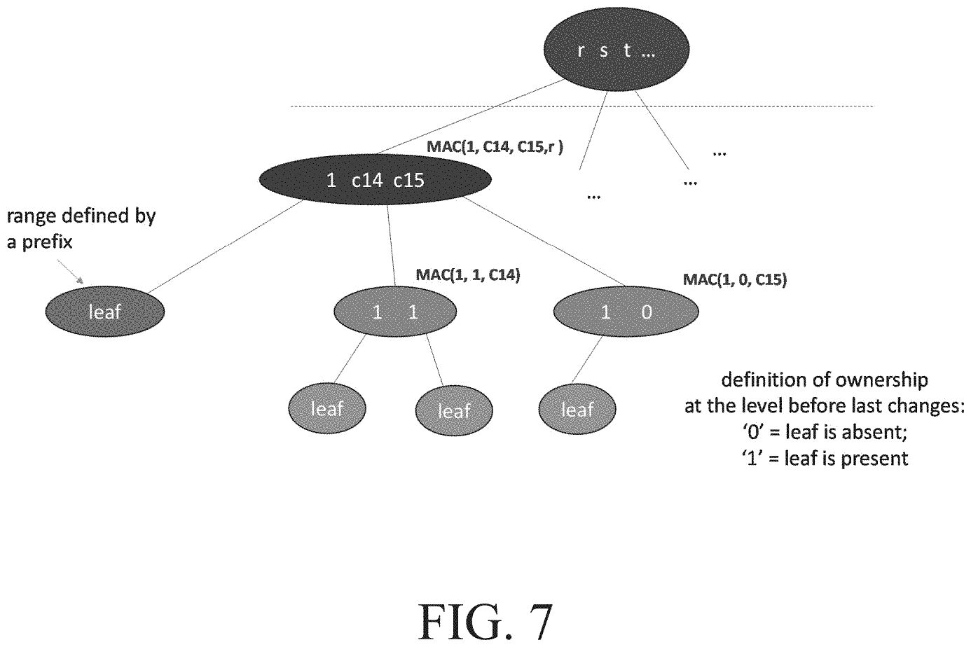

FIG. 7 illustrates how the version tree may work with ranges. For example, each leaf may be defined by a prefix (e.g., “0” for no child leaf, and “1” for a child leaf) and each MAC value including the leaf prefix data and the parent node info. This approach can provide an efficient representation for ranges of addresses.

Accordingly, the version tree structure may be modified to describe ownership and/or invalidation of pages. Also, the version tree may be compatible with ranges (as discussed with reference to FIG. 7). The version tree structure may be dynamic/scalable and grown/shrunk as needed and also flexible with implementation (as discussed with reference to positive and negative approaches). And, such embodiments can provide significant storage requirement savings.

FIG. 8 illustrates a block diagram of an SOC package in accordance with an embodiment. As illustrated in FIG. 8, SOC 802 includes one or more Central Processing Unit (CPU) cores 820, one or more Graphics Processor Unit (GPU) cores 830, an Input/Output (I/O) interface 840, and a memory controller 842. Various components of the SOC package 802 may be coupled to an interconnect or bus such as discussed herein with reference to the other figures. Also, the SOC package 802 may include more or less components, such as those discussed herein with reference to the other figures. Further, each component of the SOC package 802 may include one or more other components, e.g., as discussed with reference to the other figures herein. In one embodiment, SOC package 802 (and its components) is provided on one or more Integrated Circuit (IC) die, e.g., which are packaged into a single semiconductor device.

As illustrated in FIG. 8, SOC package 802 is coupled to a memory 860 via the memory controller 842. In an embodiment, the memory 860 (or a portion of it) can be integrated on the SOC package 802.

The I/O interface 840 may be coupled to one or more I/O devices 870, e.g., via an interconnect and/or bus such as discussed herein with reference to other figures. I/O device(s) 870 may include one or more of a keyboard, a mouse, a touchpad, a display, an image/video capture device (such as a camera or camcorder/video recorder), a touch screen, a speaker, or the like.

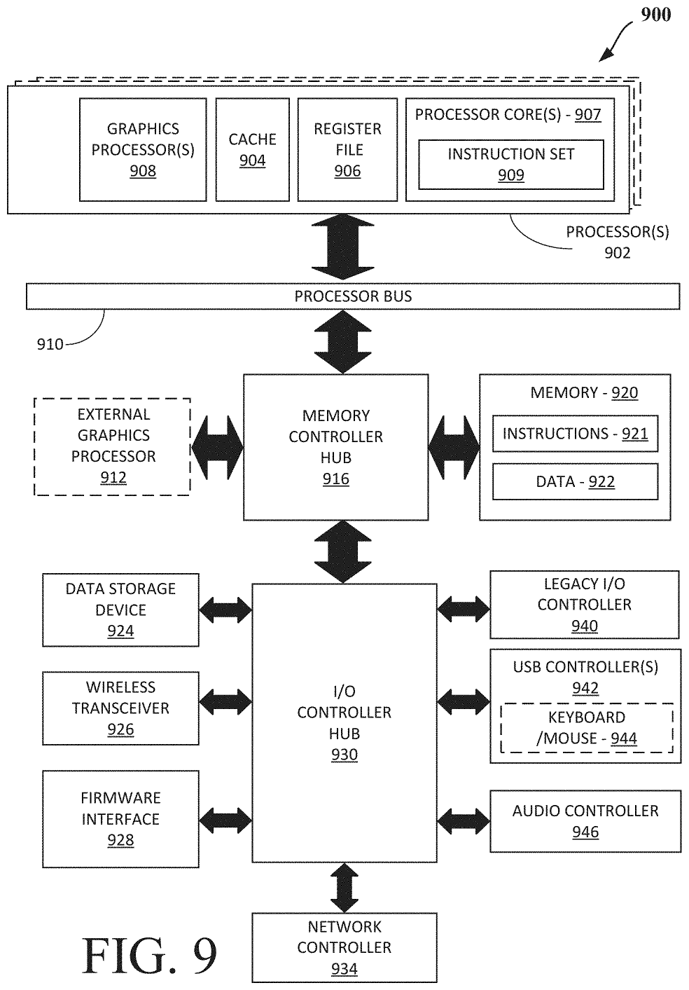

FIG. 9 is a block diagram of a processing system 900, according to an embodiment. In various embodiments the system 900 includes one or more processors 902 and one or more graphics processors 908, and may be a single processor desktop system, a multiprocessor workstation system, or a server system having a large number of processors 902 or processor cores 907. In on embodiment, the system 900 is a processing platform incorporated within a system-on-a-chip (SoC or SOC) integrated circuit for use in mobile, handheld, or embedded devices.

An embodiment of system 900 can include, or be incorporated within a server-based gaming platform, a game console, including a game and media console, a mobile gaming console, a handheld game console, or an online game console. In some embodiments system 900 is a mobile phone, smart phone, tablet computing device or mobile Internet device. Data processing system 900 can also include, couple with, or be integrated within a wearable device, such as a smart watch wearable device, smart eyewear device, augmented reality device, or virtual reality device. In some embodiments, data processing system 900 is a television or set top box device having one or more processors 902 and a graphical interface generated by one or more graphics processors 908.

In some embodiments, the one or more processors 902 each include one or more processor cores 907 to process instructions which, when executed, perform operations for system and user software. In some embodiments, each of the one or more processor cores 907 is configured to process a specific instruction set 909. In some embodiments, instruction set 909 may facilitate Complex Instruction Set Computing (CISC), Reduced Instruction Set Computing (RISC), or computing via a Very Long Instruction Word (VLIW). Multiple processor cores 907 may each process a different instruction set 909, which may include instructions to facilitate the emulation of other instruction sets. Processor core 907 may also include other processing devices, such a Digital Signal Processor (DSP).

In some embodiments, the processor 902 includes cache memory 904. Depending on the architecture, the processor 902 can have a single internal cache or multiple levels of internal cache. In some embodiments, the cache memory is shared among various components of the processor 902. In some embodiments, the processor 902 also uses an external cache (e.g., a Level-3 (L3) cache or Last Level Cache (LLC)) (not shown), which may be shared among processor cores 907 using known cache coherency techniques. A register file 906 is additionally included in processor 902 which may include different types of registers for storing different types of data (e.g., integer registers, floating point registers, status registers, and an instruction pointer register). Some registers may be general-purpose registers, while other registers may be specific to the design of the processor 902.

In some embodiments, processor 902 is coupled to a processor bus 910 to transmit communication signals such as address, data, or control signals between processor 902 and other components in system 900. In one embodiment the system 900 uses an exemplary ‘hub’ system architecture, including a memory controller hub 916 and an Input Output (I/O) controller hub 930. A memory controller hub 916 facilitates communication between a memory device and other components of system 900, while an I/O Controller Hub (ICH) 930 provides connections to I/O devices via a local I/O bus. In one embodiment, the logic of the memory controller hub 916 is integrated within the processor.

Memory device 920 can be a dynamic random access memory (DRAM) device, a static random access memory (SRAM) device, flash memory device, phase-change memory device, or some other memory device having suitable performance to serve as process memory. In one embodiment the memory device 920 can operate as system memory for the system 900, to store data 922 and instructions 921 for use when the one or more processors 902 executes an application or process. Memory controller hub 916 also couples with an optional external graphics processor 912, which may communicate with the one or more graphics processors 908 in processors 902 to perform graphics and media operations.

In some embodiments, ICH 930 enables peripherals to connect to memory device 920 and processor 902 via a high-speed I/O bus. The I/O peripherals include, but are not limited to, an audio controller 946, a firmware interface 928, a wireless transceiver 926 (e.g., Wi-Fi, Bluetooth), a data storage device 924 (e.g., hard disk drive, flash memory, etc.), and a legacy I/O controller 940 for coupling legacy (e.g., Personal System 2 (PS/2)) devices to the system. One or more Universal Serial Bus (USB) controllers 942 connect input devices, such as keyboard and mouse 944 combinations. A network controller 934 may also couple to ICH 930. In some embodiments, a high-performance network controller (not shown) couples to processor bus 910. It will be appreciated that the system 900 shown is exemplary and not limiting, as other types of data processing systems that are differently configured may also be used. For example, the I/O controller hub 930 may be integrated within the one or more processor 902, or the memory controller hub 916 and I/O controller hub 930 may be integrated into a discreet external graphics processor, such as the external graphics processor 912.

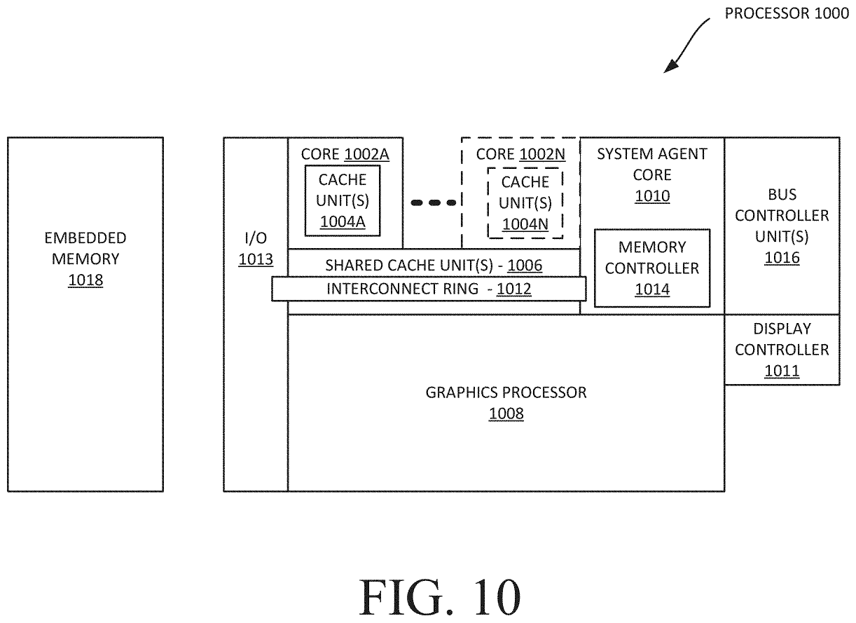

FIG. 10 is a block diagram of an embodiment of a processor 1000 having one or more processor cores 1002A to 1002N, an integrated memory controller 1014, and an integrated graphics processor 1008. Those elements of FIG. 10 having the same reference numbers (or names) as the elements of any other figure herein can operate or function in any manner similar to that described elsewhere herein, but are not limited to such. Processor 1000 can include additional cores up to and including additional core 1002N represented by the dashed lined boxes. Each of processor cores 1002A to 1002N includes one or more internal cache units 1004A to 1004N. In some embodiments each processor core also has access to one or more shared cached units 1006.

The internal cache units 1004A to 1004N and shared cache units 1006 represent a cache memory hierarchy within the processor 1000. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 1006 and 1004A to 1004N.

In some embodiments, processor 1000 may also include a set of one or more bus controller units 1016 and a system agent core 1010. The one or more bus controller units 1016 manage a set of peripheral buses, such as one or more Peripheral Component Interconnect buses (e.g., PCI, PCI Express). System agent core 1010 provides management functionality for the various processor components. In some embodiments, system agent core 1010 includes one or more integrated memory controllers 1014 to manage access to various external memory devices (not shown).

In some embodiments, one or more of the processor cores 1002A to 1002N include support for simultaneous multi-threading. In such embodiment, the system agent core 1010 includes components for coordinating and operating cores 1002A to 1002N during multi-threaded processing. System agent core 1010 may additionally include a power control unit (PCU), which includes logic and components to regulate the power state of processor cores 1002A to 1002N and graphics processor 1008.

In some embodiments, processor 1000 additionally includes graphics processor 1008 to execute graphics processing operations. In some embodiments, the graphics processor 1008 couples with the set of shared cache units 1006, and the system agent core 1010, including the one or more integrated memory controllers 1014. In some embodiments, a display controller 1011 is coupled with the graphics processor 1008 to drive graphics processor output to one or more coupled displays. In some embodiments, display controller 1011 may be a separate module coupled with the graphics processor via at least one interconnect, or may be integrated within the graphics processor 1008 or system agent core 1010.

In some embodiments, a ring based interconnect unit 1012 is used to couple the internal components of the processor 1000. However, an alternative interconnect unit may be used, such as a point-to-point interconnect, a switched interconnect, or other techniques, including techniques well known in the art. In some embodiments, graphics processor 1008 couples with the ring interconnect 1012 via an I/O link 1013.

The exemplary I/O link 1013 represents at least one of multiple varieties of I/O interconnects, including an on package I/O interconnect which facilitates communication between various processor components and a high-performance embedded memory module 1018, such as an eDRAM (or embedded DRAM) module. In some embodiments, each of the processor cores 1002A to 1002N and graphics processor 1008 use embedded memory modules 1018 as a shared Last Level Cache.

In some embodiments, processor cores 1002A to 1002N are homogenous cores executing the same instruction set architecture. In another embodiment, processor cores 1002A to 1002N are heterogeneous in terms of instruction set architecture (ISA), where one or more of processor cores 1002A to 1002N execute a first instruction set, while at least one of the other cores executes a subset of the first instruction set or a different instruction set. In one embodiment processor cores 1002A to 1002N are heterogeneous in terms of microarchitecture, where one or more cores having a relatively higher power consumption couple with one or more power cores having a lower power consumption. Additionally, processor 1000 can be implemented on one or more chips or as an SoC integrated circuit having the illustrated components, in addition to other components.

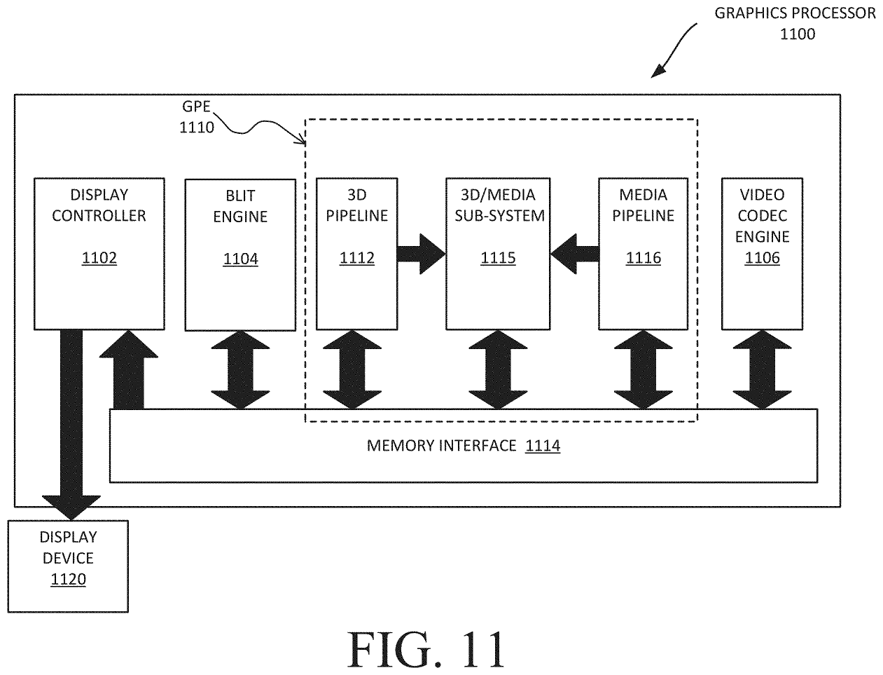

FIG. 11 is a block diagram of a graphics processor 1100, which may be a discrete graphics processing unit, or may be a graphics processor integrated with a plurality of processing cores. In some embodiments, the graphics processor communicates via a memory mapped I/O interface to registers on the graphics processor and with commands placed into the processor memory. In some embodiments, graphics processor 1100 includes a memory interface 1114 to access memory. Memory interface 1114 can be an interface to local memory, one or more internal caches, one or more shared external caches, and/or to system memory.

In some embodiments, graphics processor 1100 also includes a display controller 1102 to drive display output data to a display device 1120. Display controller 1102 includes hardware for one or more overlay planes for the display and composition of multiple layers of video or user interface elements. In some embodiments, graphics processor 1100 includes a video codec engine 1106 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 321M/VC-1, and Joint Photographic Experts Group (JPEG) formats such as JPEG, and Motion JPEG (MJPEG) formats.

In some embodiments, graphics processor 1100 includes a block image transfer (BLIT) engine 1104 to perform two-dimensional (2D) rasterizer operations including, for example, bit-boundary block transfers. However, in one embodiment, 11D graphics operations are performed using one or more components of graphics processing engine (GPE) 1110. In some embodiments, graphics processing engine 1110 is a compute engine for performing graphics operations, including three-dimensional (3D) graphics operations and media operations.

In some embodiments, GPE 1110 includes a 3D pipeline 1112 for performing 3D operations, such as rendering three-dimensional images and scenes using processing functions that act upon 3D primitive shapes (e.g., rectangle, triangle, etc.). The 3D pipeline 1112 includes programmable and fixed function elements that perform various tasks within the element and/or spawn execution threads to a 3D/Media sub-system 1115. While 3D pipeline 1112 can be used to perform media operations, an embodiment of GPE 1110 also includes a media pipeline 1116 that is specifically used to perform media operations, such as video post-processing and image enhancement.

In some embodiments, media pipeline 1116 includes fixed function or programmable logic units to perform one or more specialized media operations, such as video decode acceleration, video de-interlacing, and video encode acceleration in place of, or on behalf of video codec engine 1106. In some embodiments, media pipeline 1116 additionally includes a thread spawning unit to spawn threads for execution on 3D/Media sub-system 1115. The spawned threads perform computations for the media operations on one or more graphics execution units included in 3D/Media sub-system 1115.

In some embodiments, 3D/Media subsystem 1115 includes logic for executing threads spawned by 3D pipeline 1112 and media pipeline 1116. In one embodiment, the pipelines send thread execution requests to 3D/Media subsystem 1115, which includes thread dispatch logic for arbitrating and dispatching the various requests to available thread execution resources. The execution resources include an array of graphics execution units to process the 3D and media threads. In some embodiments, 3D/Media subsystem 1115 includes one or more internal caches for thread instructions and data. In some embodiments, the subsystem also includes shared memory, including registers and addressable memory, to share data between threads and to store output data.

The following examples pertain to further embodiments. Example 1 includes an apparatus comprising: memory to store data for a secured device in a computing system, the stored data comprising information for one or more intermediate nodes and one or more leaf nodes, wherein each of the one or more intermediate nodes includes an intermediate node Message Authentication Code (MAC), the intermediate node MAC to authenticate contents of that intermediate node and a counter of a parent node of that intermediate node, wherein each of the one or more leaf nodes includes a leaf node Message Authentication Code (MAC), the leaf node MAC to authenticate contents of that leaf node and a counter of a parent intermediate node of that leaf node; and logic circuitry to allow or disallow access to contents of a memory region associated with a first leaf node by a memory access request based at least in part on whether the memory access request is associated with a permission authenticated by the MAC of the first leaf node. Example 2 includes the apparatus of example 1, wherein counters associated with the one or more intermediate nodes and the one or more leaf nodes are to be incremented for each corresponding write operation. Example 3 includes the apparatus of example 1, wherein the one or more intermediate nodes comprise information indicative of whether a child leaf is present or absent. Example 4 includes the apparatus of example 3, wherein the intermediate node MAC or the leaf node MAC is to be generated based on the information indicative of whether the child leaf is present or absent. Example 5 includes the apparatus of example 1, wherein the one or more intermediate nodes comprise information indicative of whether a child leaf is present or absent, wherein presence of a leaf indicates a memory page has been assigned to the secured device or that a memory page has been removed for the secured device. Example 6 includes the apparatus of example 1, wherein a counter for at least one of the one or more intermediate nodes has a first value or a second value, wherein the first value is to indicate absence of a child leaf and the second value is to indicate presence of the child leaf, wherein updating the counter is to switch the first value and second value. Example 7 includes the apparatus of example 1, wherein the data is to be encrypted prior to storage in the memory. Example 8 includes the apparatus of example 7, wherein the data is to encrypted prior to storage in the memory in accordance with one or more of: Advanced Encryption Standard (AES) Galois/Counter Mode (GCM), block cipher processing, one or more one way cryptographic hash function(s), stream cipher processing, Hashed Message Authentication Code (HMAC), and Keyed Message Authentication Code (KMAC). Example 9 includes the apparatus of example 1, wherein the counter of the parent node for the intermediate node MAC is a root node or another intermediate node. Example 10 includes the apparatus of example 1, wherein the contents of the intermediate node comprises one or more counters for one or more child leaf nodes of the intermediate node. Example 11 includes the apparatus of example 1, wherein each of the one or more leaf nodes includes the leaf node MAC and one or more permissions to indicate whether the corresponding leaf node is authorized to perform a memory access operation to a host physical address. Example 12 includes the apparatus of example 11, wherein the one or more permissions comprise a read permission or a write permission. Example 13 includes the apparatus of example 1, wherein each of the one or more intermediate nodes includes one or more intermediate pointers, wherein each of the one or more intermediate pointers is to point to one of the one or more leaf nodes. Example 14 includes the apparatus of example 1, wherein the memory is outside of a processor semiconductor package. Example 15 includes the apparatus of example 1, wherein each of the one or more leaf nodes is to correspond to a peripheral device. Example 16 includes the apparatus of example 1, wherein the secured device is to be secured in accordance with Address Translation Services (ATS). Example 17 includes the apparatus of example 1, wherein the memory comprises memory located outside of a processor semiconductor package, wherein the memory is vulnerable to unauthorized physical corruption. Example 18 includes the apparatus of example 1, wherein each of the one or more leaf nodes is to correspond to a Peripheral Component Interconnect express (PCIe) device. Example 19 includes the apparatus of example 1, wherein the computing system comprises a processor, having one or more processor cores, wherein the processor comprises the logic circuitry.

Example 20 includes one or more computer-readable medium comprising one or more instructions that when executed on at least one processor configure the at least one processor to perform one or more operations to: store data in memory for a secured device in a computing system, the stored data comprising information for one or more intermediate nodes and one or more leaf nodes, wherein each of the one or more intermediate nodes includes an intermediate node Message Authentication Code (MAC), the intermediate node MAC to authenticate contents of that intermediate node and a counter of a parent node of that intermediate node, wherein each of the one or more leaf nodes includes a leaf node Message Authentication Code (MAC), the leaf node MAC to authenticate contents of that leaf node and a counter of a parent intermediate node of that leaf node; and allow or disallow access to contents of a memory region associated with a first leaf node by a memory access request based at least in part on whether the memory access request is associated with a permission authenticated by the MAC of the first leaf node. Example 21 includes the one or more computer-readable media of example 20, further comprising one or more instructions that when executed on the at least one processor configure the at least one processor to perform one or more operations to increment counters associated with the one or more intermediate nodes and the one or more leaf nodes for each corresponding write operation. Example 22 includes the one or more computer-readable media of example 20, further comprising one or more instructions that when executed on the at least one processor configure the at least one processor to perform one or more operations to encrypt the data prior to storage in the memory.

Example 23 includes a method comprising: storing data in memory for a secured device in a computing system, the stored data comprising information for one or more intermediate nodes and one or more leaf nodes, wherein each of the one or more intermediate nodes includes an intermediate node Message Authentication Code (MAC), the intermediate node MAC to authenticate contents of that intermediate node and a counter of a parent node of that intermediate node, wherein each of the one or more leaf nodes includes a leaf node Message Authentication Code (MAC), the leaf node MAC to authenticate contents of that leaf node and a counter of a parent intermediate node of that leaf node; and allowing or disallowing access to contents of a memory region associated with a first leaf node by a memory access request based at least in part on whether the memory access request is associated with a permission authenticated by the MAC of the first leaf node. Example 24 includes the method of example 23, further comprising incrementing counters associated with the one or more intermediate nodes and the one or more leaf nodes for each corresponding write operation. Example 25 includes the method of example 23, further comprising encrypting the data prior to storage in the memory.

Example 26 includes an apparatus comprising means to perform a method as set forth in any preceding example. Example 27 includes machine-readable storage including machine-readable instructions, when executed, to implement a method or realize an apparatus as set forth in any preceding example.

In various embodiments, the operations discussed herein, e.g., with reference to FIG. 1 et seq., may be implemented as hardware (e.g., logic circuitry or more generally circuitry or circuit), software, firmware, or combinations thereof, which may be provided as a computer program product, e.g., including a tangible (e.g., non-transitory) machine-readable or computer-readable medium having stored thereon instructions (or software procedures) used to program a computer to perform a process discussed herein. The machine-readable medium may include a storage device such as those discussed with respect to FIG. 1 et seq.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
memory to store data for a secured device in a computing system, the stored data comprising information for one or more intermediate nodes and one or more leaf nodes,
wherein each of the one or more intermediate nodes includes an intermediate node Message Authentication Code (MAC), the intermediate node MAC to authenticate contents of that intermediate node and a counter of a parent node of that intermediate node, wherein each of the one or more leaf nodes includes a leaf node Message Authentication Code (MAC), the leaf node MAC to authenticate contents of that leaf node and a counter of a parent intermediate node of that leaf node; and
logic circuitry to allow or disallow access to contents of a memory region associated with a first leaf node by a memory access request based at least in part on whether the memory access request is associated with a permission authenticated by the MAC of the first leaf node.

2. The apparatus of claim 1, wherein counters associated with the one or more intermediate nodes and the one or more leaf nodes are to be incremented for each corresponding write operation.

3. The apparatus of claim 1, wherein the one or more intermediate nodes comprise information indicative of whether a child leaf is present or absent.

4. The apparatus of claim 3, wherein the intermediate node MAC or the leaf node MAC is to be generated based on the information indicative of whether the child leaf is present or absent.

5. The apparatus of claim 1, wherein the one or more intermediate nodes comprise information indicative of whether a child leaf is present or absent, wherein presence of a leaf indicates a memory page has been assigned to the secured device or that a memory page has been removed for the secured device.

6. The apparatus of claim 1, wherein a counter for at least one of the one or more intermediate nodes has a first value or a second value, wherein the first value is to indicate absence of a child leaf and the second value is to indicate presence of the child leaf, wherein updating the counter is to switch the first value and second value.

7. The apparatus of claim 1, wherein the data is to be encrypted prior to storage in the memory.

8. The apparatus of claim 7, wherein the data is to encrypted prior to storage in the memory in accordance with one or more of: Advanced Encryption Standard (AES) Galois/Counter Mode (GCM), block cipher processing, one or more one way cryptographic hash function(s), stream cipher processing, Hashed Message Authentication Code (HMAC), and Keyed Message Authentication Code (KMAC).

9. The apparatus of claim 1, wherein the counter of the parent node for the intermediate node MAC is a root node or another intermediate node.

10. The apparatus of claim 1, wherein the contents of the intermediate node comprises one or more counters for one or more child leaf nodes of the intermediate node.

11. The apparatus of claim 1, wherein each of the one or more leaf nodes includes the leaf node MAC and one or more permissions to indicate whether the corresponding leaf node is authorized to perform a memory access operation to a host physical address.

12. The apparatus of claim 11, wherein the one or more permissions comprise a read permission or a write permission.

13. The apparatus of claim 1, wherein each of the one or more intermediate nodes includes one or more intermediate pointers, wherein each of the one or more intermediate pointers is to point to one of the one or more leaf nodes.

14. The apparatus of claim 1, wherein the memory is outside of a processor semiconductor package.

15. The apparatus of claim 1, wherein each of the one or more leaf nodes is to correspond to a peripheral device.

16. The apparatus of claim 1, wherein the secured device is to be secured in accordance with Address Translation Services (ATS).

17. The apparatus of claim 1, wherein the memory comprises memory located outside of a processor semiconductor package, wherein the memory is vulnerable to unauthorized physical corruption.

18. The apparatus of claim 1, wherein each of the one or more leaf nodes is to correspond to a Peripheral Component Interconnect express (PCIe) device.

19. The apparatus of claim 1, wherein the computing system comprises a processor, having one or more processor cores, wherein the processor comprises the logic circuitry.

20. One or more computer-readable medium comprising one or more instructions that when executed on at least one processor configure the at least one processor to perform one or more operations to:
store data in memory for a secured device in a computing system, the stored data comprising information for one or more intermediate nodes and one or more leaf nodes,
wherein each of the one or more intermediate nodes includes an intermediate node Message Authentication Code (MAC), the intermediate node MAC to authenticate contents of that intermediate node and a counter of a parent node of that intermediate node, wherein each of the one or more leaf nodes includes a leaf node Message Authentication Code (MAC), the leaf node MAC to authenticate contents of that leaf node and a counter of a parent intermediate node of that leaf node; and
allow or disallow access to contents of a memory region associated with a first leaf node by a memory access request based at least in part on whether the memory access request is associated with a permission authenticated by the MAC of the first leaf node.

21. The one or more computer-readable media of claim 20, further comprising one or more instructions that when executed on the at least one processor configure the at least one processor to perform one or more operations to increment counters associated with the one or more intermediate nodes and the one or more leaf nodes for each corresponding write operation.

22. The one or more computer-readable media of claim 20, further comprising one or more instructions that when executed on the at least one processor configure the at least one processor to perform one or more operations to encrypt the data prior to storage in the memory.

23. A method comprising:
storing data in memory for a secured device in a computing system, the stored data comprising information for one or more intermediate nodes and one or more leaf nodes,
wherein each of the one or more intermediate nodes includes an intermediate node Message Authentication Code (MAC), the intermediate node MAC to authenticate contents of that intermediate node and a counter of a parent node of that intermediate node, wherein each of the one or more leaf nodes includes a leaf node Message Authentication Code (MAC), the leaf node MAC to authenticate contents of that leaf node and a counter of a parent intermediate node of that leaf node; and
allowing or disallowing access to contents of a memory region associated with a first leaf node by a memory access request based at least in part on whether the memory access request is associated with a permission authenticated by the MAC of the first leaf node.

24. The method of claim 23, further comprising incrementing counters associated with the one or more intermediate nodes and the one or more leaf nodes for each corresponding write operation.

25. The method of claim 23, further comprising encrypting the data prior to storage in the memory.
